(19) United States
(12) Patent Application Publication
(10) Pub. No.: US 2012/0092384 A1
(43) Pub. Date: Apr. 19, 2012

(54) METHOD FOR CONTROLLING BACKLIGHT AND BACKLIGHT MODULE

(76) Inventor: HSIN-WEN CHANG, Miao-Li County (TW)

(21) Appl. No.: 13/035,002

(22) Filed: Feb. 25, 2011

(30) Foreign Application Priority Data
Oct. 19, 2010 (TW) 99135605

(51) Int. Cl. G09G 5/10

(52) U.S. Cl. 345/690; 345/207

(57) ABSTRACT

A method for controlling backlight and a backlight module are provided. A backlight module separated into a central illumination area and peripheral illumination areas and including a plurality of light sources is provided. The central illumination area and the peripheral illumination areas are corresponding to at least one light source respectively. First driving signals is input to the backlight module, so as a second brightness generated by each peripheral illumination area is smaller than a first brightness generated by the central illumination area. An operation is performed according to each first driving signal, the first brightness, and the second brightness, so as to obtain a second driving signal. The first driving signals and the second driving signals are input to the backlight module, so as to drive the light elements. Therefore, the brightness of the central illumination area is close to that of the peripheral illumination areas.

### CROSS-REFERENCE TO RELATED APPLICATION

This application claims the priority benefit of Taiwan application serial no. 99135605, filed on Oct. 19, 2010. The entirety of the above-mentioned patent application is hereby incorporated by reference herein and made a part of this specification.

### BACKGROUND OF THE INVENTION

1. Field of the Invention

The present invention generally relates to a backlight module and a method for controlling backlight, in particular, to a edge type backlight module and a method for controlling backlight.

2. Description of Related Art

Two main means of a liquid crystal display includes a liquid crystal display panel and a backlight module. The liquid crystal display panel does not have a function of emitting lights, such that a backlight module needs to be configured under the liquid crystal display panel for providing an enough illumination, so the liquid crystal display panel can display images.

In order to improve a display image quality of the liquid crystal display panel, a scan backlight module is provided on the market. An application principle of the scan backlight module is mainly that corresponding to different display areas on the liquid crystal display panel, an optical source of the backlight module is respectively switched at different times according to display demands, that is, a partitioned light emitting manner is adopted, so as to prevent human eyes seeing a frame change procedure. Specifically, in a direct type backlight module, the light source of each area is lighted sequentially, so as to easily achieve the partitioned light emitting purpose, but a defect of direct type backlight module is thick thickness. In a edge type backlight module, in order to achieve the partitioned light emitting purpose, an independent light guiding plate is adopted in each partitioned illuminating area, and the independent light guiding plates are assembled, such that the entire thickness is small. When an area of the edge type backlight module is lighted to be a bright area, although an adjacent dark area is not lighted, a part of light of the bright area penetrates junction surfaces between the adjacent independent light guiding plates and diffuses to the dark area, even a part of the light penetrates into next junction surface between the independent light guiding plates to be diffused to the next dark area. In this manner, for the entire light emitting of the backlight module, central area of the assembled light guiding plate has more accumulated light and is brighter, but the upper and the lower areas (that is, peripheral areas) have less accumulated light and are darker (that is, the brightness is not enough), especially for the areas nearer to upper and lower side edges of the backlight module, the brightness difference is larger, such that the display quality of the liquid crystal display is affected.

### SUMMARY OF THE INVENTION

Accordingly, the present invention is directed to a method for controlling backlight, capable of solving a defect that an optical quality of a scan backlight module is poor.

The present invention is also directed to a backlight module having a uniform illumination.

The present invention provides a method for controlling backlight, which includes the following steps. A backlight module is provided, in which the backlight module is separated into a central illumination area and a plurality of peripheral illumination areas, the peripheral illumination areas are configured on two opposite sides of the central illumination area, the backlight module includes a plurality of light sources, and the central illumination area and the peripheral illumination areas are respectively corresponding to at least one light source. A plurality of first driving signals is input to the backlight module, so as to drive the light sources, and a first brightness of the central illumination area and a second brightness of each peripheral illumination area are detected, in which each second brightness is smaller than the first brightness. An operation is performed according to each first driving signal, the first brightness, and the second brightness, so as to obtain a second driving signal. The first driving signals and the second driving signals are input to the backlight module, so as to drive the light sources, such that the brightness of the central illumination area is close to the brightness of the peripheral illumination areas.

In an embodiment of the present invention, the operation is that an equation P2=(L1/L2)*P1 is computed, P1 is a current value of the first driving signal, L1 is the first brightness, L2 is the second brightness, and P2 is a current value of the second driving signal.

In an embodiment of the present invention, the operation is that an equation D2=(L1/L2)*D1 is computed, D1 is a duty cycle of the first driving signal, L1 is the first brightness, L2 is the second brightness, and D2 is a duty cycle of the second driving signal.

In an embodiment of the present invention, the method for controlling backlight further includes: performing real-time detection, so as to obtain a third brightness of the central illumination area and a fourth brightness of each peripheral illumination area; performing re-computation according to each first driving signal, the third brightness, and each fourth brightness, so as to obtain a fourth driving signal; and inputting the first driving signals and the fourth driving signals to the backlight module, so as to drive the light sources, such that the brightness of the central illumination area is close to the brightness of the peripheral illumination area.

In an embodiment of the present invention, the backlight module is a edge type backlight module.

In an embodiment of the present invention, the backlight module further includes a light guiding plate. The light sources are configured on at least one side edge of the light guiding plate, and the light guiding plate is formed by a plurality of sub light-guide-plates.

In an embodiment of the present invention, the light sources are plurality of light emitting diodes (LEDs).

The present invention further provides a backlight module, which includes a light guiding plate, a plurality of light elements, and a driving unit. The light guiding plate includes a plurality of sub light-guide-plates, in which the sub light-guide-plates are separated into a central sub light-guide-plate and a plurality of peripheral sub light-guide-plates, and the peripheral sub light-guide-plates are configured on two opposite sides of the central sub light-guide-plate. The light sources are configured on at least one side edge of the light guiding plate, and configured corresponding to the central sub light-guide-plate and the peripheral sub light-guide-plates. The driving unit is electrically connected to the light sources and has at least two different driving signals, in which the different driving signals respectively drive the light sources corresponding to the central sub light-guide-plate and the peripheral sub light-guide-plates, such that an brightness of a central illumination area is close to an brightness of peripheral illumination areas.

In an embodiment of the present invention, the backlight module further includes a plurality of optical sensing elements, configured adjacent to the sub light-guide-plates, and electrically connected to the driving unit, for detecting an brightness of the central sub light-guide-plate and an brightness of the peripheral sub light-guide-plates in real time.

In an embodiment of the present invention, the optical sensing elements are a plurality of photodiodes (PDs).

In an embodiment of the present invention, the light sources are a plurality of LEDs.

In an embodiment of the present invention, the driving signals of the light sources corresponding to the central sub light-guide-plate are smaller than the driving signals of the light sources corresponding to the peripheral sub light-guide-plates.

In view of the above mentioned, in the method for controlling backlight according to the present invention, an operation is performed on a first driving signal, a first brightness, and second brightness, so as to obtain a second driving signal, and then the computed second driving signals are input to the backlight module. In this manner, an brightness of a central illumination area is close to an brightness of peripheral illumination areas, such that a backlight module achieves a uniform light emitting effect, and has an excellent optical quality.

In order to make the aforementioned features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a method for controlling backlight according to an embodiment of the present invention.

FIG. 2 is a schematic view of a backlight module according to an embodiment of the present invention.

FIG. 3 is a schematic view of another backlight module according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

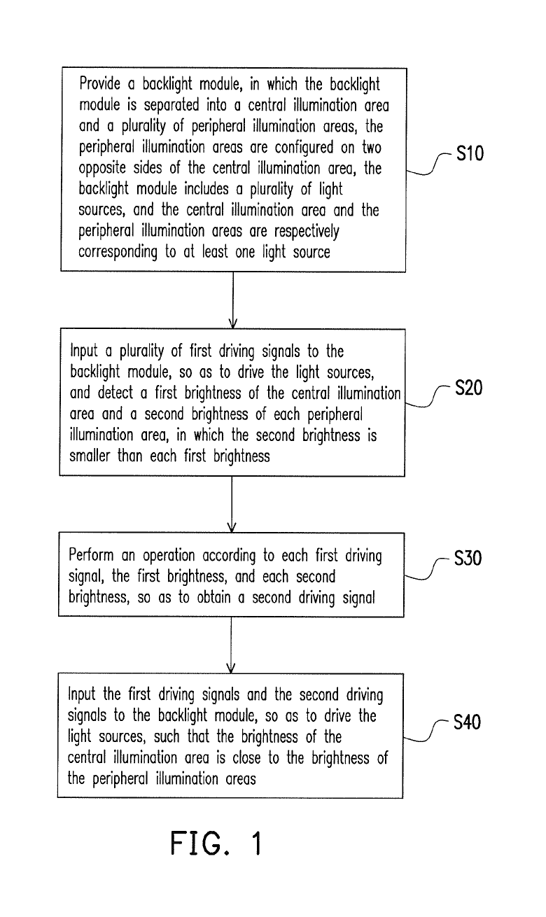

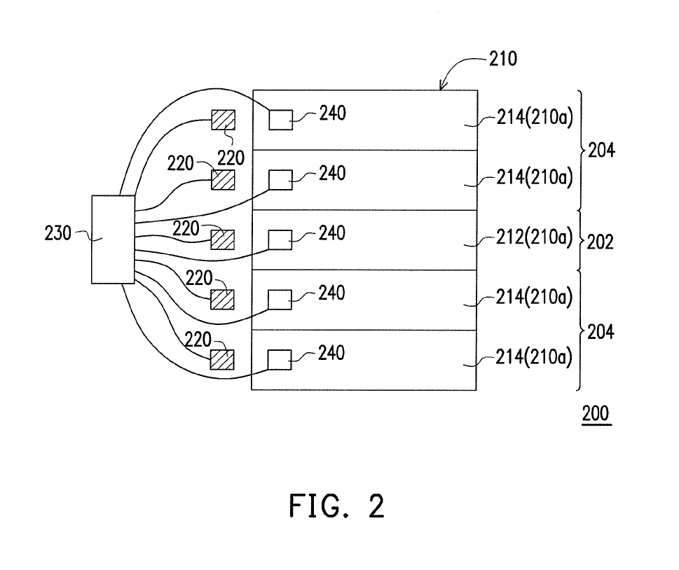

FIG. 1 is a flow chart of a method for controlling backlight according to an embodiment of the present invention, and FIG. 2 is a schematic view of a backlight module according to an embodiment of the present invention. Referring to FIGS. 1 and 2, in the method for controlling backlight according to this embodiment, firstly, in Step S10, a backlight module 200 is provided, in which the backlight module 200 is a edge type backlight module. Specifically, the backlight module 200 is separated into a central illumination area 202 and a plurality of peripheral illumination areas 204, in which the peripheral illumination areas 204 are configured on two opposite sides of the central illumination area 202.

Referring to FIG. 2, the backlight module 200 according to this embodiment includes a light guiding plate 210, a plurality of light sources 220, and a driving unit 230. The light guiding plate 210 has a plurality of sub light-guide-plates 210a, in which the sub light-guide-plates 210a are distinguished into a central sub light-guide-plate 212 and a plurality of peripheral sub light-guide-plates 214, and the peripheral sub light-guide-plates 214 are configured on two opposite sides of the central sub light-guide-plate 212. Specifically, the peripheral sub light-guide-plates 214 are correspondingly configured in the peripheral illumination areas 204, and the central sub light-guide-plate 212 is correspondingly configured in the central illumination area 202. The light sources 220 are configured on at least one side edge of the light guiding plate 210 (FIG. 2 schematically shows that the light sources 220 are configured on a side edge of the light guiding plate 210), and respectively configured corresponding to the central sub light-guide-plate 212 and the peripheral sub light-guide-plates 214, in which the central illumination area 202 and the peripheral illumination areas 204 are respectively corresponding to at least one light source 220. In this embodiment, the light sources 220 are a plurality of LEDs. In addition, the driving unit 230 is electrically connected to the light sources 220.

It should be mentioned that in the present invention, the corresponding configuration manner of the sub light-guide-plates 214 and the central illumination area 202 and the peripheral illumination areas 204 is not limited. Here, although only one central sub light-guide-plate 212 is configured in the central illumination area 202, and two peripheral sub light-guide-plates 214 are configured in each peripheral illumination area 204, in other embodiments, a plurality of central sub light-guide-plates 212 may also be configured in the central illumination area 214, and at least one peripheral sub light-guide-plate 214 may be configured in each peripheral illumination area 204, which is the technical solution adopted by the present invention without departing from the protection scope of the present invention.

Next, referring to FIG. 1, in Step S20, a plurality of first driving signals is input to the backlight module 200, so as to drive the light sources 220, and a first brightness of the central illumination area 202 and a second brightness of each peripheral illumination area 204 are detected, in which each second brightness is smaller than the first brightness. Specifically, in this embodiment, the driving unit 230 provides the first driving signals, in which the first driving signals are the same, for respectively driving the light sources 220 corresponding to the central sub light-guide-plate 212 and the peripheral sub light-guide-plates 214. The light guiding plate 210 according to this embodiment is formed by the sub light-guide-plates 210a, such that when the light sources 220 are driven to generate the brightness, a part of light entering the light guiding plate 210 may penetrate junction surfaces between the sub light-guide-plates 210a and diffuse to the adjacent sub light-guide-plates 210a, such that the first brightness of the central illumination area 202 is larger than the second brightness of the peripheral illumination areas 204.

Then, in order to make the first brightness of the central illumination area 202 be close to the second brightness of the peripheral illumination areas 204, in Step S30, an operation is performed according to the first driving signal, the first brightness, and the second brightness, so as to obtain a second driving signal, in which the operation is that an equation P2=(L1/L2)*P1 is computed, in which P1 is a current value of the first driving signal, L1 is the first brightness of the central illumination area 202, L2 is the second brightness of the peripheral illumination area 204, and P2 is a current value of the second driving signal.

Generally, the second brightness of the peripheral illumination area 204 above the central illumination area 202 is approximately the same as the second brightness of the peripheral illumination area 204 under the central illumination area 202, such that one of the second brightness of the peripheral illumination area 204 above the central illumination area 202 and the second brightness of the peripheral illumination area 204 under the central illumination area 202 is used to perform the operation. Further, the second brightness is smaller than the first brightness, such that the current value of the second driving signal is greater than the current value of the first driving signal.

Finally, in Step S40, the second driving signals are input to a second brightness area of the backlight module 200, that is, the light sources 220 corresponding to the peripheral illumination areas 204, so as to drive the light sources 220, such that the brightness of the peripheral illumination areas 204 is close to the brightness of the central illumination area 202. In brief, in this embodiment, the driving signals are adjusted according to the brightness of the central illumination area 202 and the brightness of the peripheral illumination areas 204, the adjusted driving signals (that is, the second driving signals) may be different according to different positions of the central illumination area 202 and the peripheral illumination areas 204, but the detected brightness of each area is the same or close to one another after the adjusted driving signals are input to the peripheral illumination areas 204. In this manner, the purpose that the brightness of the central illumination area 202 is close to the brightness of the peripheral illumination areas 204 is achieved.

Here, it should be described that although the brightness of the peripheral illumination areas 204 is changed through the current value of the second driving signal, so as to achieve the purpose that the brightness of the central illumination area 202 is close to the brightness of the peripheral illumination areas 204, in other embodiments, the brightness of the central illumination area 202 and the brightness of the peripheral illumination areas 204 are changed through a duty cycle of the second driving signal, in which the operation is that an equation D2=(L1/L2)*D1 is computed, D1 is a duty cycle of the first driving signal, L1 is a first brightness of the central illumination area 202, L2 is the second brightness of the peripheral illumination area 204, and D2 is the duty of the second driving signal, which is the technical solution adopted by the present invention without departing from the protection scope of the present invention.

In brief, in the method for controlling backlight according to the present invention, the operation is performed on the first driving signal, the first brightness, and the second brightness, so as to obtain the second driving signal. Then, the second driving signals are input to the backlight module 200, so as to adjust the brightness of the peripheral illumination areas 204. In this embodiment, the brightness of the central illumination area 202 and the brightness of the peripheral illumination areas 204 are changed by adjusting the current value of the driving signal or the duty cycle of the signal. In this manner, the brightness of the central illumination area 202 is close to the brightness of the peripheral illumination areas 204, such that the backlight module 200 achieves a uniform light emitting effect, and has an excellent optical quality.

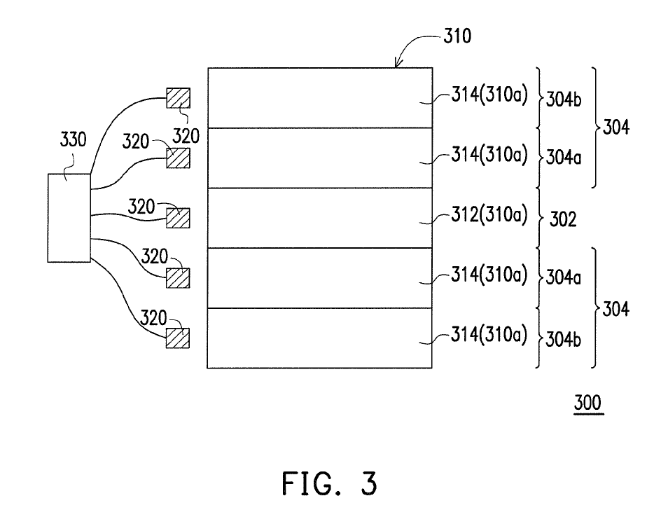

Referring to FIG. 3, a backlight module 300 according to this embodiment includes a light guiding plate 310, a plurality of light sources 320, and a driving unit 330. The light guiding plate 310 has a plurality of sub light-guide-plates 310a, in which the sub light-guide-plates 310a are separated into a central sub light-guide-plate 312 and a plurality of peripheral sub light-guide-plates 314, and the peripheral sub light-guide-plates 314 are configured on two opposite sides of the central sub light-guide-plate 312. Specifically, the peripheral sub light-guide-plates 314 are correspondingly configured in the peripheral illumination areas 304, and the central sub light-guide-plate 312 is correspondingly configured in the central illumination area 302, each peripheral illumination area 304 may be further separated into sub-peripheral illumination areas 304a and 304b, in which as compared with the sub-peripheral illumination area 304a, the sub-peripheral illumination area 304b is nearer to areas of upper and lower side edges of the backlight module. The light sources 320 are configured on at least one side edge of the light guiding plate 310 (FIG. 3 schematically shows that the light sources 320 are configured on one side edge of the light guiding plate 310), and are respectively corresponding to the central sub light-guide-plate 312 and the peripheral sub light-guide-plates 314, in which the central illumination area 302 and the sub-peripheral illumination areas 304a and 304b are respectively corresponding to at least one light source 320. In this embodiment, the light sources 320 are a plurality of LEDs. In addition, the driving unit 330 is electrically connected to the light sources 320.

It should be mentioned that in the present invention, the corresponding configuration manner of the sub light-guide-plates 314 and the central illumination area 302 and the sub-peripheral illumination areas 304a and 304b is not limited. Here, although only one central sub light-guide-plate 312 is configured in the central illumination area 302, and one peripheral sub light-guide-plate 314 is configured in each sub-peripheral illumination area 304a and 304b, in other embodiments, a plurality of central sub light-guide-plates 312 may also be configured in the central illumination area 314, and one peripheral sub light-guide-plate 314 or more than two peripheral sub light-guide-plates 314 may be configured in each sub-peripheral illumination area 304a and 304b, which is the technical solution adopted by the present invention without departing from the protection scope of the present invention.

The backlight control manner of this embodiment is approximately the same as that of the embodiment of FIG. 2, and only differences are described in the following.

Referring to FIG. 1, in Step S20, a plurality of first driving signals is input to the backlight module 300, so as to drive the light sources 320, and a first brightness of the central illumination area 302, second brightness of the sub-peripheral illumination area 304a, and a third brightness of the sub-peripheral illumination area 304b are detected, in which the third brightness is smaller than the second brightness, and the second brightness is smaller than the first brightness. The driving unit 330 provides the first driving signals, in which the first driving signals are the same, for respectively driving the light sources 320 corresponding to the central sub light-guide-plate 312 and the peripheral sub light-guide-plates 314.

Then, in order to make the brightness generated by the central illumination area 302 be close to the brightness generated by the sub-peripheral illumination areas 304a and 304b, in Step S30, an operation is performed according to the first driving signal, the first brightness, and the second brightness, so as to obtain a second driving signal, in which the operation is that an equation P2=(L1/L2)*P1 is computed, P1 is a current value of the first driving signal, L1 is the first brightness of the central illumination area 302, L2 is the second brightness of the sub-peripheral illumination area 304a, and P2 is a current value of the second driving signal. Similarly, an operation is performed according to the first driving signal, the first brightness, and the third brightness, so as to obtain a third driving signal, in which the operation is that an equation P3=(L1/L3)*P1 is computed, P1 is the current value of the first driving signal, L1 is the first brightness of the central illumination area 302, L3 is the third brightness of the sub-peripheral illumination area 304b, and P3 is a current value of the third driving signal. The third brightness is smaller than the second brightness, and the second brightness is smaller than the first brightness, such that the current value of the third driving signal is greater than the current value of the second driving signal, and the current value of the second driving signal is greater than the current value of the first driving signal.

Finally, in Step S40, the second driving signals are input to the light elements 320 corresponding to the sub-peripheral illumination areas 304a of the backlight module 300, the third driving signals are input to the light sources 320 corresponding to the sub-peripheral illumination areas 304b of the backlight module 300, so as to drive the light sources 220, such that the brightness of the sub-peripheral illumination areas 304a and 304b is close to the brightness of the central illumination area 302.

In this embodiment, the first driving signal, the second driving signal, and the third driving signal may also be a duty cycle. It should be noted that in this embodiment, the operation on the driving signal uses the first brightness of the central illumination area as an operation reference, and finally, the central illumination area is driven through the unadjusted first driving signal; during actual application, on the contrary, the third brightness of the sub-peripheral illumination area on the outmost side is used as the operation reference, and the sub-peripheral illumination area on the outmost side is still driven through the unadjusted first driving signal.

Referring to FIG. 2, generally, it is known that after the light sources 220 continuously emit lights for a long time, an entire temperature of the backlight module 200 increasingly rises, such that a light emitting efficiency of the light sources 220 are increasingly lowered. Therefore, the method for controlling backlight according to this embodiment further includes that real-time detection is performed, so as to obtain a third brightness of the central illumination area 202 and a fourth brightness of each peripheral illumination area 204. Specifically, the backlight module 200 according to this embodiment may further include a plurality of optical sensing elements 240, for example, PDs, configured adjacent to the light guiding plates 210, and electrically connected to the driving unit 230. Then, re-computation is performed according to each first driving signal, the third brightness, and each fourth brightness, so as to obtain a fourth driving signal. Finally, the fourth driving signals and the first driving signals are input to the backlight module 200, so as to drive the light sources 220, such that the brightness of the central illumination area 202 is close to the brightness of the peripheral illumination areas 204. In this manner, the backlight module 200 according to this embodiment achieves a uniform light emitting effect, and has an excellent optical quality.

In addition, the central sub light-guide-plates 212 and 312 and the peripheral sub light-guide-plates 214 and 314 according to the embodiment of the present invention may have the same design, and may be different in designs, for example, materials and sizes etc. according to actual demands.

In view of the above mentioned, in the method for controlling backlight according to the present invention, the operation is performed on the first driving signal, the first brightness, and the second brightness, so as to obtain the second driving signal, and then the second driving signals are input to the backlight module. In this manner, the brightness of the central illumination area is close to the brightness of the peripheral illumination areas, such that the backlight module achieves a uniform light emitting effect, and has an excellent optical quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for controlling backlight, comprising:
providing a backlight module, wherein the backlight module is separated into a central illumination area and a plurality of peripheral illumination areas, the peripheral illumination areas are configured on two opposite sides of the central illumination area, the backlight module comprises a plurality of light sources, and the central illumination area and the peripheral illumination areas are respectively corresponding to at least one light source;
inputting a plurality of first driving signals to the backlight module, so as to drive the light sources, and detecting a first brightness of the central illumination area and a second brightness of each peripheral illumination area, wherein each second brightness is smaller than the first brightness;
performing an operation according to each first driving signal, the first brightness, and the second brightness, so as to obtain a second driving signal; and
inputting the first driving signals and the second driving signals to the backlight module, so as to drive the light sources, such that the brightness of the central illumination area is close to the brightness of the peripheral illumination areas.

2. The method for controlling backlight according to claim 1, wherein the operation is that an equation P2=(L1/L2)*P1 is computed, P1 is a current value of the first driving signal, L1 is the first brightness, L2 is the second brightness, and P2 is a current value of the second driving signal.

3. The method for controlling backlight according to claim 1, wherein the operation is that an equation D2=(L1/L2)*D1 is computed, D1 is a duty cycle of the first driving signal, L1 is the first brightness, L2 is the second brightness, and D2 is a duty cycle of the second driving signal.

4. The method for controlling backlight according to claim 1, further comprising:
performing real-time detection, so as to obtain a third brightness of the central illumination area and a fourth brightness of each peripheral illumination area;
performing re-computation according to each first driving signal, the third brightness, and each fourth brightness, so as to obtain a fourth driving signal; and
inputting the first driving signals and the fourth driving signals to the backlight module, so as to drive the light sources, such that the brightness of the central illumination area is close to the brightness of the peripheral illumination area.

5. The method for controlling backlight according to claim 1, wherein the backlight module is a edge type backlight module.

6. The method for controlling backlight according to claim 5, wherein the backlight module further comprises a light guiding plate, the light sources are configured on at least one side edge of the light guiding plate, and the light guiding plate is formed by a plurality of sub light-guide-plates.

7. The method for controlling backlight according to claim 1, wherein the light sources are plurality of light emitting diodes (LEDs).

8. A backlight module, comprising:
a light guiding plate, comprising a plurality of sub light-guide-plates, wherein the sub light-guide-plates are separated into a central sub light-guide-plate and a plurality of peripheral sub light-guide-plates, and the peripheral sub light-guide-plates are configured on two opposite sides of the central sub light-guide-plate;
a plurality of light sources, configured on at least one side edge of the light guiding plate, and configured corresponding to the central sub light-guide-plate and the peripheral sub light-guide-plates; and
a driving unit, electrically connecting to the light sources and having at least two different driving signals, wherein the different driving signals respectively drive the light sources corresponding to the central sub light-guide-plate and the peripheral sub light-guide-plates, such that an brightness of a central illumination area is close to an brightness of peripheral illumination areas.

9. The backlight module according to claim 8, further comprising a plurality of optical sensing elements, configured adjacent to the sub light-guide-plates, and electrically connected to the driving unit, for detecting an brightness of the central sub light-guide-plate and an brightness of the peripheral sub light-guide-plates.

10. The backlight module according to claim 9, wherein the optical sensing elements are a plurality of photodiodes (PDs).

11. The backlight module according to claim 8, wherein the light sources are a plurality of light emitting diodes (LEDs).

12. The backlight module according to claim 8, wherein the driving signals of the light sources corresponding to the central sub light-guide-plate are smaller than the driving signals of the light sources corresponding to the peripheral sub light-guide-plates.
